(19) United States
(12) Patent Application Publication
(10) Pub. No.: US 2017/0106583 A1
(43) Pub. Date: Apr. 20, 2017

(54) COMBINATION BOND CONSISTING OF A PERMANENT LOAD-BEARING BOND AND A TEMPORARY BOND FOR FACILITATING AND ACCELERATING MANUFACTURE

(71) Applicants: Manfred Schönberger, Tacherting (DE); Michael Lindner, Traunstein (DE)

(72) Inventors: Manfred Schönberger, Tacherting (DE); Michael Lindner, Traunstein (DE)

(21) Appl. No.: 15/291,280

(22) Filed: Oct. 12, 2016

(30) Foreign Application Priority Data
Oct. 20, 2015 (EP) 15002974.2

(51) Int. Cl. B29C 65/48; B32B 37/12; B32B 38/00; B29C 35/02

(52) U.S. Cl. CPC B29C 65/48; B29C 35/02; B32B 37/1207; B32B 38/0036; B29K 2105/0097

(57) ABSTRACT

A method for adhesively bonding a first component to a second component, the two components being bonded, for preliminary fixing, with a first adhesive to form a first adhesive bond, and the two components being bonded, for producing an elastic second adhesive bond, with a second adhesive. The first adhesive bond after the second adhesive bond has been cured is stressed in such a way that it is destroyed so the second adhesive bond is elastically deformable unhindered by the first adhesive bond. An assembly produced in such a way is also described.

The invention relates to a method for adhesively bonding two components and also to an assembly produced by the method.

Adhesive bonding has been undergoing a massive boom for years and is increasingly on the point of replacing conventional joining techniques such as welding or riveting.

When adhesive bonds are exposed to dynamic stresses, it is advisable to use elastically deformable adhesive bonds. All such bonds, however, require a greater or lesser time for attaining the ultimate strength.

This circumstance, however, delays manufacture and reduces throughput.

On this basis, the object of the present invention is that of providing a method for adhesively bonding two components that counters the above-stated problems.

This object is achieved by a method having the features described below.

The invention provides a method for adhesively bonding a first component to a second component, the two components, for preliminary fixing, i.e. production of a temporary fastening, being bonded with a first adhesive to form a first adhesive bond, and the two components, for producing a permanent, elastic second adhesive bond, being bonded with a second adhesive, where the first adhesive bond after the second adhesive bond has been cured is stressed in such a way that it is destroyed, and so the second adhesive bond is elastically deformable unhindered by the first adhesive bond.

According to one embodiment of the invention, the stressing may preferably involve mechanical stressing, where a mechanical force is directed into the first adhesive bond in order to destroy it. According to another embodiment of the invention, alternatively, the first adhesive bond may be destroyed chemically, in particular by contacting the first adhesive bond with a suitable substance or chemical that destroys or separates the first adhesive bond. Furthermore, in accordance with another embodiment, the first adhesive bond may also be stressed thermally and destroyed in the process, by heating the first adhesive bond. Lastly, any desired combination of the above-described forms of stressing the first adhesive bond may be applied, leading to the destruction of the first adhesive bond.

The curing of the second adhesive bond means here preferably that the second adhesive bond has attained a strength which, when the bonded components are used as intended, guarantees that the second adhesive bond is not destroyed. The cured state of the second adhesive bond here may even be present at a point in time at which the maximum, ultimate strength of the second adhesive bond has not yet been attained.

The aim of the combined bonding with a first adhesive (e.g. cyanoacrylate adhesive; see below) and with an elastic second adhesive (e.g. PU adhesive; see below), in accordance with the invention, is to facilitate and accelerate the manufacture of the adhesive bond. Here, the quick-setting first adhesive serves for rapid fixing of the components to be bonded. Dynamic stresses which occur later can be accommodated by the first adhesive (e.g. cyanoacrylate adhesive) only to a limited extent. Accordingly, there is a deliberate failure of the first adhesive bond (e.g. cyanoacrylate adhesive layer). As a result, the bond, specifically the second adhesive bond, can then be elastically deformed without hindrance. The first adhesive, accordingly, has only a temporary function during manufacture and is intended subsequently to fail under stress.

In accordance with one preferred embodiment of the invention, therefore, the two adhesives are selected such that the first adhesive bond has a shorter cure time than the second adhesive bond. With regard to the second adhesive bond, the cure time is preferably the time during which the second adhesive bond has attained the sufficient strength set out above. With regard to the first adhesive, the cure time preferably denotes the time which the first adhesive or the first adhesive bond requires in order to attain at least 90%, preferably at least 95%, preferably 100% of the ultimate strength.

According to a further embodiment of the invention, first of all, the first and second adhesives are each applied to the first and/or second component(s), after which the two components are brought into their intended position relative to one another, which is maintained at least during the curing of the first adhesive bond.

Provision is further made, according to one preferred embodiment of the invention, for the two components, after the curing of the first adhesive bond and/or after elapse of the cure time of the first adhesive bond, and before the curing of the second adhesive bond (i.e. before elapse of the cure time of the second adhesive bond), to be jointly moved (in particular such that their relative position to one another is not changed) and/or joined to at least one further component, allowing, in particular, time to be saved during a production operation, there being no need first to await the curing of the second adhesive bond.

In accordance with one preferred embodiment of the invention, the first adhesive comprises cyanoacrylate.

The compounds in question here are esters of cyanoacrylic acid (e.g. methyl 2-cyanoacrylate, n-butyl cyanoacrylate and 2-octyl cyanoacrylate). A cyanoacrylate-containing adhesive of this kind (particularly a one-part adhesive) may be present in the form of monomers, which react by polymerization reaction in the joint gap between the two components, to form the actual adhesive polymer. The polymerization which leads to the curing is governed by polar groups or particles, examples being the OH ions in the layer of moisture on the component surfaces to be bonded, this being known as anionic polymerization.

In accordance with a further preferred embodiment of the invention, the second adhesive comprises PU (i.e. polyurethane).

Polyurethane adhesives of this kind may take the form basically of one-part or two-part adhesives, which are able to cure by polyaddition. According to one embodiment of the invention, a one-part PU adhesive is used, which cures, for example, by addition of atmospheric moisture and/or of heat.

A PU adhesive which can be used in the context of the invention may further comprise one of the following compounds: diphenylmethane 4,4′-diisocyanate (MDI), isophorone diisocyanate (IPDI), tolylene diisocyanate (TDI), hexamethylene diisocyanate (HDI).

According to one embodiment of the invention, the first adhesive bond or the first adhesive has a cure time in the range from a few seconds to a few hours, e.g. in the range from 1 second to 3 hours.

Furthermore, according to one embodiment of the invention, the second adhesive bond or the second adhesive has a cure time in the range from a few hours to several days, e.g. in the range from 3 hours to 7 days.

Furthermore, according to one preferred embodiment of the invention, the second adhesive bond in the cured state has a modulus of elasticity of below 1000 MPa, preferably below 100 MPa, more preferably below 15 MPa.

The modulus of elasticity of the second adhesive bond is preferably lower than the modulus of elasticity of the first adhesive bond.

The method of the invention is used with particular preference with first (or second) components which comprise or consist of a metal, and/or with second (or first) components which comprise or consist of a plastic.

Disclosed according to a further aspect of the invention is an assembly which comprises at least a first component and a second component, the two components being joined to one another by means of a method according to the description herein.

The first (or second) component may consist in this case of a metal or comprise a metal, while the second (or first) component consists of a plastic or comprises a plastic.

The first or second component is preferably one of the following components: a vibration damper or a component thereof, an assembly aid (e.g. for components with thermal expansion), a heat exchanger (e.g. a helically coiled or a plate-type heat exchanger), a component of a heat exchanger (e.g. of a helically coiled or a plate-type heat exchanger), a vehicle, more particularly motor vehicle, a component of a vehicle, more particularly of a motor vehicle, an aircraft, a component of an aircraft, a seal.

The method of the invention can be employed in particular for producing structural bonds in the motor vehicle sector or between motor-vehicle components.

The method of the invention is more particularly an advantageous procedure or technical teaching which makes it possible to minimize assembly times, since to date, for example, either rivets or screws have been used, additionally to the adhesive bonding, in order to ensure “rapid hold”, or long cure times (in some cases with heat treatment as well) have been used.

An advantage of the present invention in particular is that elastic bonds can be established precisely, since there is no longer any time pressure.

The method of the invention can be applied to virtually all adhesive bonds where bonding already takes place today. From car windscreens via aircraft construction through to vibration damping and heat exchanger construction.

The elasticity modulus of the second adhesive is preferably adjustable, specifically according to application. For example, a low elasticity modulus is used preferably for vibration damping, whereas with strength bonds the elasticity modulus is preferably adjusted so as to be as far as possible identical to the elasticity modulus of the components/materials being bonded.

In the case of heat exchangers, moreover, a second adhesive is used, for example, which has the same or a similar coefficient of thermal expansion as the heat exchanger components to be bonded, in the working range or temperature range of the heat exchanger.

In the case of mechanical destruction, the elongation at break for the first adhesive is of course to be extremely low.

The strengths of the adhesive bonds are adjusted preferably by way of bond areas.

Further features and advantages of the invention will be elucidated in the descriptions below of figures of working examples of the invention, using the figures.

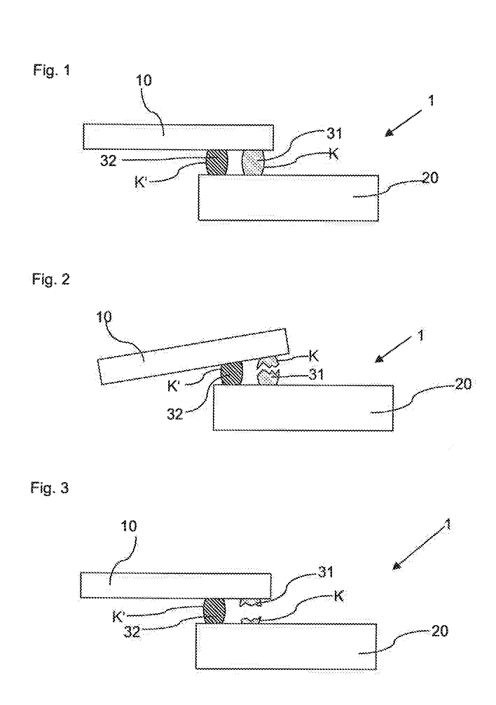

FIG. 1 to FIG. 3 show schematic sectional views of an inventively performed adhesive bond between a first and a second component.

FIGS. 1, 2 and 3 show a method for producing a bond between two components 10, 20 by adhesive bonding.

In this method, the two components 10, 20 are bonded to one another, for the purpose of preliminary fixing of the two components to one another, with a first adhesive K to form a first adhesive bond 31.

Between the two components 10, 20, moreover, a second adhesive bond 32 is created, which is intended later to provide an elastically deformable connection between the two components 10, 20.

Since, however, this second adhesive bond 32 requires a longer cure time, the spatial position of the two components 10, 20 relative to one another is fixed with the preliminary-fixing first adhesive bond 31, allowing the second adhesive bond 32 to cure without disruption. In this case, optionally, the two components 10, 20 can be jointly moved or further-processed in some other way, producing a corresponding time saving in the production of an assembly 1 comprising the two components 10, 20.

After the second adhesive bond 32 has cured, the first adhesive bond 31 is intentionally (e.g. dynamically) stressed (cf. FIG. 2) in such a way that it is destroyed, and the second adhesive bond 32 is now elastically deformable unhindered by the first adhesive bond 31 (cf. FIG. 3). Stressing of this kind may therefore be performed deliberately during the production of the assembly 1 (that is, in particular, before the assembly 1 is dispatched). Destruction of the first adhesive bond 31 in accordance with FIG. 2 may also not occur until during or after the commencement of operation, or during the operation, of the assembly 1, so that the first adhesive bond 31 fails or is destroyed only at that point in time, i.e. during the as-intended operation of the assembly 1.

The first adhesive K according to one example of the invention is an adhesive K which comprises cyanoacrylate. Furthermore, according to one example of the invention, the second adhesive K′ is an adhesive K′ which comprises polyurethane (PU).

### REFERENCE SYMBOLS

| | |
|---|---|
| 1 | Assembly |
| 10 | First component |
| 20 | Second component |
| 31 | First adhesive bond |
| 32 | Second adhesive bond |
| K | First adhesive |
| K′ | Second adhesive |

1. A method for adhesively bonding a first component to a second component, the first component and the second component being bonded, for preliminary fixing, with a first adhesive to form a first adhesive bond, and the first component and the second component being bonded, for producing an elastic second adhesive bond, with a second adhesive, where the first adhesive bond after the second adhesive bond has been cured is stressed in such a way that it is destroyed, and so the second adhesive bond is elastically deformable unhindered by the first adhesive bond.

2. The method according to claim 1, characterized in that the stressing is chemical, thermal and/or mechanical.

3. The method according to claim 1, characterized in that the first adhesive and the second adhesive are selected such that the first adhesive bond has a shorter cure time than the second adhesive bond.

4. The method according to claim 1, characterized in that the first adhesive bond has a lower strength than the second adhesive bond.

5. The method according to claim 1, characterized in that the first adhesive comprises cyanoacrylate.

6. The method according to claim 1, characterized in that the second adhesive comprises PU.

7. The method according to claim 1, characterized in that adhesive bond has a cure time in the range from 1 second to three hours.

8. The method according to claim 1, characterized in that the second adhesive bond has a cure time in the range from 3 hours to 7 days.

9. The method according to claim 1, characterized in that the second adhesive bond in the cured state or in the operational state has a lower modulus of elasticity than the first adhesive bond in the cured state or in the operational state, the modulus of elasticity of the second adhesive bond being less than 1000 MPa.

10. The method according to claim 9, characterized in that the modulus of elasticity of the second adhesive bond being less than 100 MPa.

11. The method according to claim 10, characterized in the modulus of elasticity of the second adhesive bond being less than 15 MPa.

12. The method according to claim 1, characterized in that the first component is a vibration damper, a component of a vibration damper, an assembly aid, a heat exchanger, a component of a heat exchanger, a vehicle, a motor vehicle, a component of a vehicle, a component of a motor vehicle, an aircraft, or a component of an aircraft.

13. The method according to claim 1, characterized in that the second component is a vibration damper, a component of a vibration damper, an assembly aid, a heat exchanger, a component of a heat exchanger, a vehicle, a motor vehicle, a component of a vehicle, a component of a motor vehicle, an aircraft, or a component of an aircraft.

14. An assembly comprising at least a first component and a second component, the first component and the second two being joined to one another by a method for adhesively bonding the first component to the second component, the first component and the second component being bonded, for preliminary fixing, with a first adhesive to form a first adhesive bond, and the first component and the second component being bonded, for producing an elastic second adhesive bond, with a second adhesive, where the first adhesive bond after the second adhesive bond has been cured is stressed in such a way that it is destroyed, and so the second adhesive bond is elastically deformable unhindered by the first adhesive bond.

15. The assembly according to claim 14, characterized in that the first component is a vibration damper, a component of a vibration damper, an assembly aid, a heat exchanger, a component of a heat exchanger, a vehicle, a motor vehicle, a component of a vehicle, a component of a motor vehicle, an aircraft, or a component of an aircraft.

16. The assembly according to claim 14, characterized in that the second component is a vibration damper, a component of a vibration damper, an assembly aid, a heat exchanger, a component of a heat exchanger, a vehicle, a motor vehicle, a component of a vehicle, a component of a motor vehicle, an aircraft, or a component of an aircraft.

17. A method for adhesively bonding a first component to a second component, the method comprising:
bonding the first component to the second component using a first adhesive to form a first adhesive bond;
bonding the first component and the second component using a second adhesive to form an elastic second adhesive bond;
curing the second adhesive bond;
destroying the first adhesive bond;
wherein the second adhesive bond is elastically deformable unhindered by the first adhesive bond.
